(19) United States
(12) Patent Application Publication
(10) Pub. No.: US 2005/0258314 A1
(43) Pub. Date: Nov. 24, 2005

(54) Cable holding device

(76) Inventors: Wilfried Schilles, Sontra (DE); Sebastian Wandtke, Gottingen (DE)

Correspondence Address: Andrew R Basile;Young & Basile, 3001 West Big Beaver Rd, Suite 624, Troy, MI, 48084, US

(21) Appl. No.: 10/519,426

(22) PCT Filed: Jun. 25, 2003
(86) PCT No.: PCT/EP03/06712

§ 371 Date: Dec. 22, 2004

(30) Foreign Application Priority Data
Jun. 25, 2002 (DE) 202-10-024.3

(51) Int. Cl. F16L 3/08; E04G 3/00; A47B 96/06

(52) U.S. Cl. 248/74.1; 248/229.16

(57) ABSTRACT

Disclosed is a cable holding device particularly for an electrical cable in motor vehicles. Said cable holding device comprises a circumferential element fixing the cable and a base locking the cable holding device in an opening of a motor vehicle door or similar. The circumferential element can be closed in order to fully encompass the cable.

### BACKGROUND OF THE INVENTION

The present invention relates to a cable holding device.

Cable holding devices are required in various technical fields. In particular, particular demands are set with regard to the fixation of cables on movable objects such as e.g. motor vehicles. Here the aim is for a cable to be fixed to be held in its position despite the movement of the objects, and for it not to be damaged by way of abrasion on surrounding objects.

Cable holding devices are already known for fixing electrical cables on motor vehicles. These, as peripheral elements for fixing the cable, comprise two webs which are inclined to one another and which form a clip for fixing a cable. These webs are provided with a locking foot for firmly locking the cable holding device in an opening of a motor vehicle door or likewise.

This cable holding device according to the state of the art has several disadvantages.

On the one hand the cable holding device with regard to its size must be matched relatively exactly to the cable to be fixed. If a cable or a cable loom has a diameter which is too large for the clip-like holding device, then this holding device may be destroyed. If a cable has a diameter which is too small then it may slip out of the cable holding device so that this may no longer fulfil its holding function.

On the other hand the known cable holding device permits no satisfactory guiding of the cable to be held. The holding device, in the direction of the cable axis, mostly has a length which is too short in order to be able to adequately guide the cable. If this length is increased with a known cable holding device, then under certain conditions this may no longer be operated in a simple manner since the stiffness of the clip webs increases with an increasing length or the passing-through is rendered more difficult.

It is therefore the object of the present invention to provide a cable holding device which on the one hand offers a secure retention which is largely independent of the diameter of a cable to be fixed, furthermore has a good guiding property in particular for flexible cables, and furthermore is simple to assemble and is inexpensive to manufacture.

### SUMMARY OF THE INVENTION

By way of the fact that with a cable holding device of the known type, the peripheral element may be closed for the complete peripheral encompassing of the cable, all cables which have a smaller diameter than the inner diameter of the peripheral element are held in a firm manner.

The closure of the peripheral element may preferably be effected by one hand. In the closed position a relative high stiffness of the peripheral element and thus an improved retention force results as a result of the closed shape. Furthermore the peripheral element may have practically any length in the direction of the cable axis so that flexible cables in particular are well guided. A secure retention of cable strands, e.g. also in the wet region of a motor vehicle door (i.e. in the region between an outer skin of a motor vehicle door and a fluid-tight wall arranged towards the vehicle interior) is rendered possible. At the same time, despite this, an axial displaceability of the cable continues to be ensured. The assembly of the cable holding device e.g. in a door inner [sheet] plate of the motor vehicle door is possible with one hand without auxiliary means. One may set infinitely large holding forces or holding lengths. In particular, on account of the completely peripheral peripheral element, it is ensured that no audible development of noise is produced by way of a cable sliding out of the peripheral element (this ensures good results in the “squeak and rattle test”). Thus as a whole there results a safer, rattle-free guiding of the cable as well as the possibility of a quick assembly.

Advantageous further designs of the present invention are specified hereinafter.

One advantageous further design envisages the peripheral element to comprise a snap-closure to be opened. This means that the peripheral element is to be opened and closed in a reversible manner so that a simple assembly is possible also in the case of repairs or cables to be re-equipped. In particular, here it lends itself for the peripheral element to comprise two cylinder halves connected via a hinge. In this case the peripheral element perpendicularly to the introduction direction of the cable (i.e. to the longitudinal axis direction of the cable) has an essentially annular cross-section; of course other cross sections are also possible (polygonal or oval cross sections). The peripheral element thus comprises a guide casing which runs axially to the introduction direction of the cable (i.e. in the direction of the cable longitudinal axis). By way of this a loop formation of the cable is prevented over a desired length. The guide casing however does not necessarily have to have a cylinder shape. Arcuate construction shapes (S-shaped, V-shaped or W-shaped curvature in the direction of the cable longitudinal axis) are possible. At the same time the guide casing in the introduction direction of the cable preferably has a length of two to ten times the inner diameter of the peripheral element.

A particularly advantageous further design envisages the peripheral element or the guide casing to comprise ends widened in the introduction direction of the cable. The ends thus have e.g. a “trumpet shape”. By way of this a sharp bending of the cable which may cause damage to the cable is prevented, and simultaneously the introduction direction or the pulling-through of the cables in the introduction direction (i.e. along the central axis of the guide cylinder) is simplified.

A further advantageous design envisages the guide casing being connected to the locking foot of the cable holding device via support ribs. By way of this a high stiffness of the arrangement is achieved without an increased use of material.

The locking foot preferably comprises several snap lugs for engaging behind the opening of a motor vehicle door or likewise. These may preferably be arranged along an imagined circular line so that the cable holding device when required may be turned in the opening.

A particularly advantageous design envisages the locking foot to comprises a sealing lip which may be tensioned on locking the locking foot in the opening of the motor vehicle door or likewise, for sealing the openings of the motor vehicle door. This is particularly important when the cable holding device according to the invention is inserted e.g. in a door module or a door inner [sheet] plate which separate the dry region from the wet region of a door. By way of the sealing lip which according to the invention may be tensioned by locking, here one simultaneously achieves a fluid-tight closure of the separating wall (i.e. of the door inner [sheet] plate or of the door module). This too is possible in a simple manner with a one-handed operation, without having to carry out additional sealing measures at a later stage.

One further advantageous further design envisages the cable holding device to comprise a wedge with an associated wedge guide for spreading open (expanding) and fixing the locking foot in the opening. This further development of conventional snap lugs has the advantage that a fixation of the snap lugs (supported in force by way of the wedge introduction) is possible quasi independently of the properties of the peripheral edge of the opening. The opening therefore e.g. does not have to be deburred at its edges in an cost-intensive manner. Any burr e.g. consisting of metal in the peripheral edging may under certain conditions even improve the retention of a snap lug consisting of plastic since the plastic here additionally claws in the metal.

A further advantageous further design envisages the wedge perpendicular to the guide direction of the wedge guide to have a T-shaped cross-section. By way of this the stability of the wedge is increased, the pressing-in by hand is also possible in a simpler manner since the contact surface is increased. The incorporation of several locking steps permits a secure clamping of the wedge and thus a corresponding snap lug in various or varying opening geometries.

It is particularly advantageous for the cable holding device according to the invention to be manufacturable as one piece. A hinge on the peripheral element may e.g. be designed as a film rail which is to be integrally injection moulded. Plastics, in particular polypropylene lend themselves as materials. This may be easily injection moulded. The present cable holding device is capable of being manufactured in a relatively simply shaped injection mould (a “mould free of injection-slides (gates)” without undercuts).

### BRIEF DESCRIPTION OF THE DRAWINGS

The present invention is now explained by way of several figures. There are shown in:

FIGS. 1a to 2c various views or sections of a cable holding device according to the invention.

FIGS. 3a and 3b views or sections of a locking foot to be fixed by way of wedge displacement.

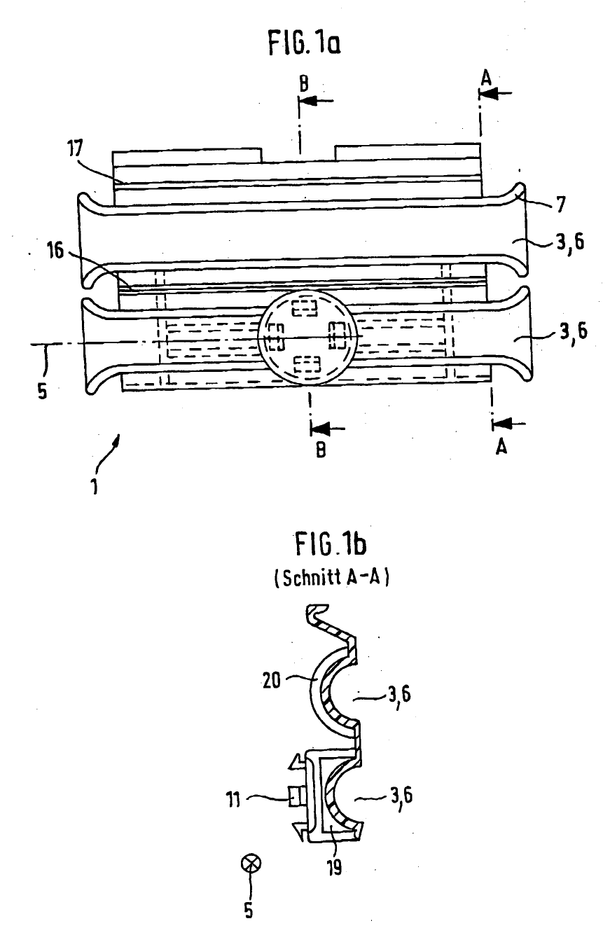

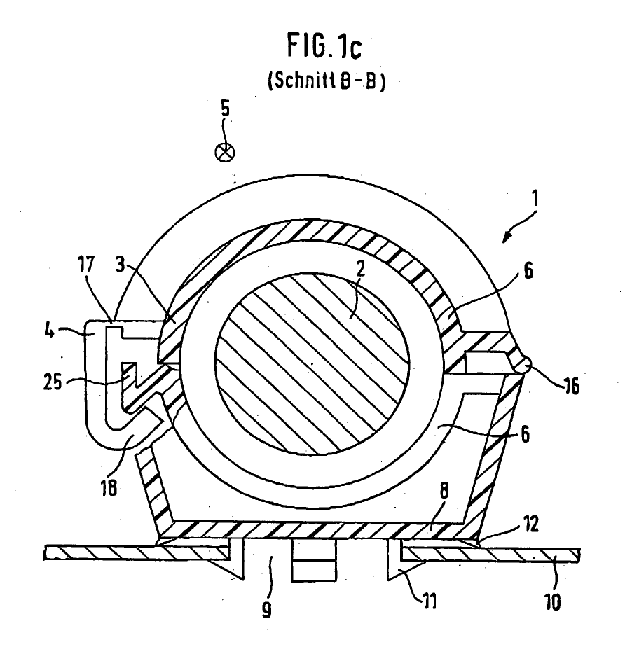

FIGS. 1a to 1c show various views or sections of a first embodiment of a cable holding device according to the invention.

### DETAILED DESCRIPTION OF THE PREFERRED EMBODIMENT

Here FIG. 1a shows a view of a one-piece cable holding device 1, whose peripheral element 3 comprises a guide casing 6 to be opened. The guide casing 6 consists of two cylinder halves, as is evident in FIG. 1b, which shows the section A-A. The cylinder shape of the guide casing 6 which exists in the closed condition of the peripheral element 6 is evident in FIG. 1c which represents the section B-B.

In FIGS. 1a to 1c therefore a cable holding device 1 is to be seen with a peripheral element 3 for fixing a cable 2 and with a locking foot 8 for firmly locking the cable holding device 1 into an opening 9 of a motor vehicle door 10 (of course any other openings may be considered here). The peripheral element 3 to which the guide casing 6 belongs may be closed for the complete peripheral encompassing of the cable 2. The peripheral element 3 apart from a guide casing 6 also comprises a film hinge 16 for connecting the semi-cylindrical halves of the guide casing 6. In FIG. 1c on the left half one may also see the snap closure 4 which is joined on as one piece. This comprises a hook which is joined on the cylinder half which is at the top in FIG. 1c and which is pivotable about a film hinge 17. A hook 18 is attached at the end of the snap closure 4 and this hook engages behind a projection which is attached on the lower cylinder half in FIG. 1c and thus retains the peripheral element 3 or the guide casing 6 in its reversible, closed position. The projection which is attached on the lower cylinder half in FIG. 1c has an essentially perpendicularly upwardly pointing web 25 which is provided as a locking aid. This component is helpful for locking, but however is not absolutely necessary (see also FIG. 1b): Generally various locking mechanisms are possible, in particular locking and unlocking forces of the tube locking 18 may be changed in a simple manner due to design.

One may easily recognise from FIG. 1c that the guide casing 6 comprises a round cross section which in the closed condition is perpendicular to the introduction direction or the axis direction 5 of the cable 2. The shape of the guide casing 6 in the direction 5 is evident from FIG. 1a. Here one may recognise that the guide casing is essentially designed as a cylinder. Of course it is also possible for arcuate construction shapes e.g. S-shaped, V-shaped or W-shaped courses to result in the direction 5. The guide casing at the ends 7 of the guide casing are widened in a trumpet-like manner so that a sharp bending of a cable led out of the guide casing 6 is limited to a minimum. The ratio of the largest inner diameter (thus quasi at the exit of the “trumpet”) and the inner diameter is the non-widened region of the guide casing 6 at the same time preferably lies at 1:1 to 4:1.

From FIG. 1b one may deduce that the peripheral element 3 further comprises support ribs 19 which are arranged perpendicularly to the direction 5 and which connect the lower part of the guide casing 6 to the base surface of the locking foot 8.

Furthermore it is possible to provide a stiffening of the upper part of the guide casing 6 by way of support ribs 20.

The locking foot 8 is dealt with in the following.

This comprises several snap lugs 11 which (as is to be seen in FIG. 1c) engage behind the edge region of an opening 9 with a 1.5 mm thick sheet metal layer (other sheet thicknesses are also conceivable, e.g. 0.5 to 3 mm or more) of a motor vehicle door inner [sheet] plate (differently long snap lugs are to be provided depending on the thickness of the sheet metal layer, this however is taken into account with a corresponding design of the tool for manufacturing the snap lugs). The snap lugs 11 project from the base plane of the locking foot 8. Furthermore a sealing lip 12 (or only one support collar) which is peripheral to the edge region of the base plane is provided on this base plane. This sealing lip or this support collar is designed such that on snapping the snap lugs 111 into the opening 9, the sealing lip or the support collar is tensioned so that in the case of a sealing lip the opening 9 is closed in a fluid-tight manner by way of the sealing lip 12 and the base plane of the locking foot 8. The locking hooks 11 may also be fixed in an absolute manner by way of an expansion pin.

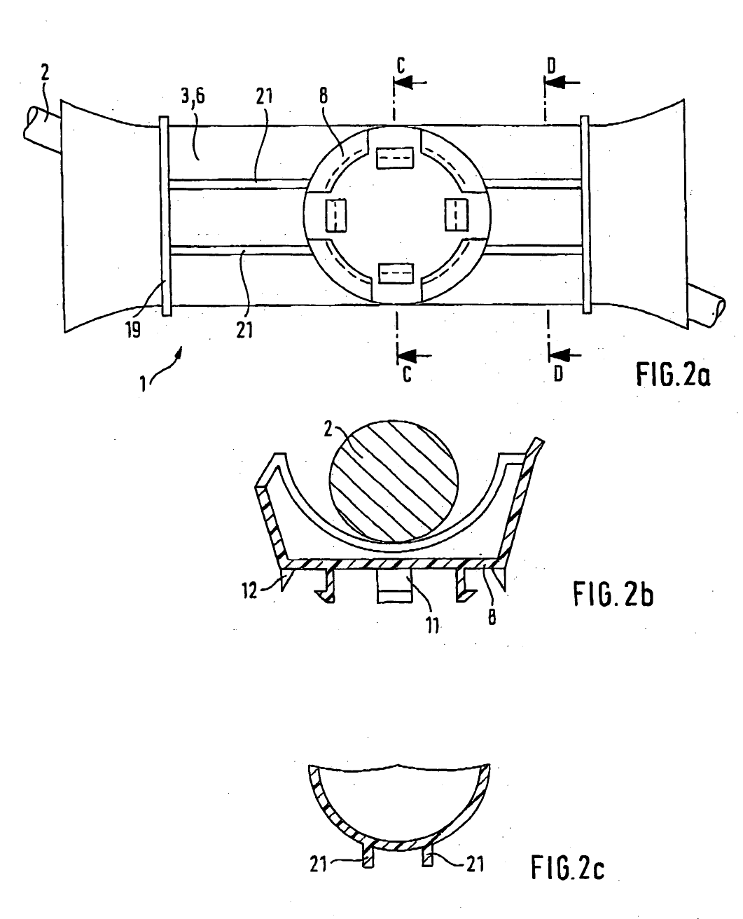

FIGS. 2a to 2c illustrate further possible details of a cable holding device according to the invention. Here only the locking foot 8 with a semi-cylindrical half of the guide casing 6 joined thereto is shown. The upper half of the guide casing 6 has not been shown for reasons of an improved overview.

A view from below of the cable holding device 1 according to the invention is shown in FIG. 2a. Here stiffening ribs 19 are shown running in the longitudinal direction of the guide casing 6. Support ribs 21 which are connected thereto are also to be seen.

FIG. 2b shows a section according to C-C, FIG. 2c shows a section according to D-D, wherein the support ribs 21 are to be seen.

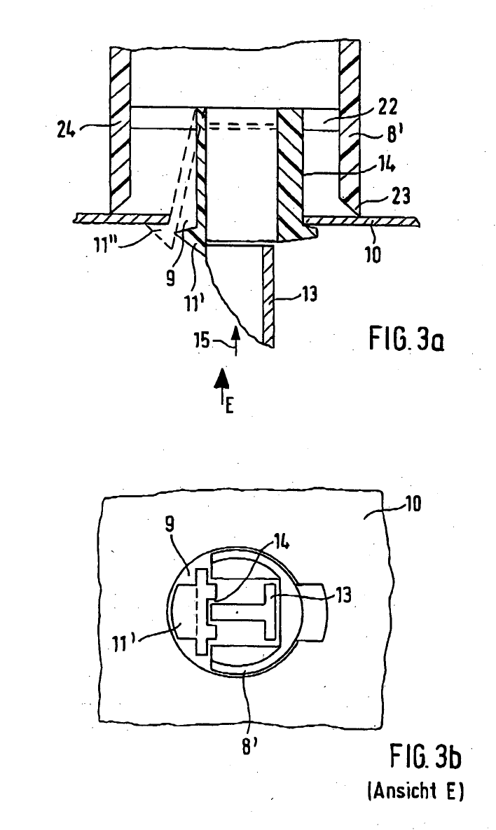

FIGS. 3a and 3b show details of an alternative embodiment of the locking foot. The locking foot 8′ shown in FIGS. 3a and 3b is connected to the peripheral element 3 described above. For avoiding repetition, the repeated representation of this peripheral element has been omitted.

The locking foot 8′ comprises an essentially circularly cylindrical periphery 24 (other shapes are also possible) in which a base plane 22 is incorporated as an intermediate base. On the side which faces the motor vehicle door 10 or the opening, the cylinder 24 comprises a sharp-edged sealing lip 23 which on locking the locking foot may form a fluid-tight termination of the opening 9.

At least one snap lug and a fixed hook (as a counter bearing) project from the intermediate base 22. Such a snap lug is indicated in its initial position at 11′ in FIG. 3a. In its sealing position in which it locks the locking foot in the opening 9, it is indicated in FIG. 3a at 11′.

The locking foot 8 furthermore comprises a wedge 13 with an associated wedge guide 14 for expanding and fixing the locking foot 8′ in the opening 9.

This wedge 13 is shown in its initial position in FIG. 3a. On introducing the wedge 13 in the direction 15 along the guide 14, the snap lug 11′ is moved into the position 11″ so that it sealingly fixes the locking foot with respect to the opening 9. An incorporation of several locking steps permits a secure clamping of the wedge 13 and thus of the snap lug 11 in different or varying opening geometries.

FIG. 3b shows a section E as indicated in FIG. 3a. Here one may see that the wedge 13 seen in the guide direction 15 comprises a T-shaped cross-section. The snap lug 11′ is located in the initial position. The locking of the locking foot 8′ in the opening 9 which is described above takes place by way of introducing the wedge 13 into the plane of the page.

The cable holding devices described above are preferably manufacturable as one piece of plastics with the injection moulding method. At the same time polypropylene is to be particularly recommended as a material.

The assembly of this cable holding device according to the invention in the inside of motor vehicle door is particularly recommended as the application purpose. The application however should not be limited to this field.

1. A cable holding device, in particular for one or more electrical cables on motor vehicles, with a peripheral element for fixing the cable and with a locking foot for firmly locking the cable holding device in an opening of a motor vehicle door or likewise, wherein the peripheral element is closable for completely peripherally encompassing the cable and wherein the cable holding device comprises a wedge with an associated wedge guide for expanding and fixing the locking foot in the opening.

2. A cable holding device according to claim 1, characterised in that the peripheral element comprises a snap closure to be opened.

3. A cable holding device according to claim 1, characterised in that the peripheral element has an essentially annular cross-section perpendicular to the introduction direction of the cable.

4. A cable holding device according to claim 1, characterised in that the peripheral element comprises a guide casing arranged coaxially to the introduction direction.

5. A cable holding device according to claim 4, characterised in that the guide casing in the introduction direction of the cable has a length of two to ten times the smallest inner diameter of the peripheral element.

6. A cable holding device according to claim 4, characterised in that the guide casing in the introduction direction of the cable comprises widened-out ends.

7. A cable holding device according to claim 4, characterised in that the guide casing is connected to the locking foot via support ribs which belong to the peripheral element.

8. A cable holding device according to claim 1, characterised in that the locking foot comprises several snap lugs for engaging behind the opening of a motor vehicle door or likewise.

9. A cable holding device according to claim 1, characterised in that the locking foot comprises a sealing lip which may be tensioned on locking the locking foot in the opening, for sealing the opening.

10. (canceled)

11. A cable holding device according to claim 1, characterised in that the wedge perpendicular to the guide direction of the wedge guide has a T-shaped cross section.

12. A cable holding device according to claim 1, characterised in that the device is one piece.

13. A cable holding device according claim 1, characterised in that the device is made of plastic, preferably of polypropylene.

14. A motor vehicle door having a supporting base structure with an opening for holding the cable holding device of claim 1.
